(19) United States
(12) Patent Application Publication
(10) Pub. No.: US 2026/0061875 A1
(43) Pub. Date: Mar. 5, 2026

(54) METHOD FOR OPERATING A VEHICLE, RESPECTIVE VEHICLE, AND COMPUTER PROGRAM PRODUCT

(71) Applicant: AUDI AG, lngolstadt (DE)

(72) Inventors: Stefan HACKNER, Greding (DE); Roland TORNAR, Hitzhofen (DE)

(73) Assignee: AUDI AG, lngolstadt (DE)

(21) Appl. No.: 19/298,684

(22) Filed: Aug. 13, 2025

(30) Foreign Application Priority Data
Sep. 3, 2024 (DE) 102024125126.3

(51) Int. Cl. B60L 53/62; B60L 53/16; B60L 53/51; B60L 53/63

(52) U.S. Cl. CPC B60L 53/62; B60L 53/16; B60L 53/51; B60L 53/63; B60L 2240/80

(57) ABSTRACT

A method for operating a motor vehicle having an electric drive device, a traction battery connected to the drive device, and a charging port connected to the traction battery via a switch arrangement. The switch arrangement opens in a first switching state to interrupt an electrical connection between the traction battery and the charging port and closes in a second switching state to establish the electrical connection. During charging of the traction battery by electrical energy at the charging port with the switch arrangement set to the second switching state, a charging output is determined, and if the charging output falls below a threshold value, the charging of the traction battery terminates. A time duration until a renewed charging of the traction battery is predicted based a state variable and the switch arrangement is held in the second switching state if the time duration falls below a time threshold value.

### FIELD

The invention relates to a method for operating a motor vehicle having an electric drive device, a traction battery electrically connected to the drive device, and a charging port electrically connected to the traction battery via a switch arrangement, wherein the switch arrangement is opened in a first switching state to interrupt an electrical connection between the traction battery and the charging port and is closed in a second switching state to establish the electrical connection. The invention further relates to a motor vehicle and a computer program product.

### BACKGROUND

DE 10 2022 126 413 A1 is known from the prior art, for example. This document describes a vehicle charging system, comprising: a protection system including at least one contactor; and a control module programmed to command the at least one contactor to remain in a closed position upon vehicle shutdown if it is predicted that a charging event is likely to occur following the vehicle shutdown. In the closed position, the at least one contactor operatively connects a traction battery pack to a charging port assembly of the vehicle charging system. For example, the at least one contactor is held in the closed position for a threshold period after a vehicle shutdown. Preferably, the threshold period will be at least two minutes.

Furthermore, the document DE 10 2022 119 768 A1 discloses a method for charging an electric vehicle, wherein a charging controller of the electric vehicle specifies a default value for the charging current intensity or charging output of a charging current drawn by the electric vehicle in a time-varying manner.

In addition, the document DE 10 2011 089 230 A1 discloses a charging device for an electric vehicle, which device can be coupled to an electrical supply system of a building, having at least one data interface for receiving generation data containing information about electrical energy provided to the supply system by an energy generation device of the building. The at least one data interface is configured to receive consumption data containing information about electrical energy drawn from the supply system by at least one electrical consumer of the building, and charging of an electrical energy storage device of the electric vehicle can be carried out depending on both the generation data and the consumption data.

### SUMMARY

It is the object of the invention to propose a method for operating a motor vehicle which has advantages over known methods, in particular enabling charging of the traction battery with little wear of the switch arrangement even when the electrical output of a power source changes.

This is achieved, according to the invention, with a method for operating a motor vehicle. During charging of the traction battery by means of electrical energy provided at the charging port with the switch arrangement set to the second switching state, a charging output is determined, and if the charging output falls below a threshold value, the charging of the traction battery is terminated, wherein a time period until a new charging of the traction battery is predictively determined based on at least one state variable and the switch arrangement is held in the second switching state if the time period falls below a time threshold value and is set to the first switching state if the time period exceeds the time threshold value.

Advantageous embodiments with expedient further developments of the invention are specified in the description. It is pointed out that the exemplary embodiments explained in the description are not limiting; rather, any variations of the features disclosed in the description, the claims, and the figures can be implemented.

The method is used for operating the motor vehicle. This vehicle has at least the electric drive device, the traction battery, the switch arrangement, and the charging port. The drive device is used to drive the motor vehicle and thus to provide a drive torque that is aimed at driving the motor vehicle. To provide the drive torque, the drive device has at least one drive unit which is designed as an electric traction machine. The motor vehicle can be designed as an electric vehicle or as a hybrid vehicle. In the latter case, in addition to the electric traction machine, the vehicle has another drive unit, which is in the form of an internal combustion engine, for example.

The electric traction machine is connected to the traction battery and is operated at least temporarily with electrical energy which is taken from the traction battery. In addition, it may be intended to temporarily store energy provided by the traction machine in the traction battery. From time to time, the traction battery should be charged with electrical energy provided by an external power source, for example from a charging station or the like. For this purpose, the motor vehicle has a charging port, which is in the form of a charging socket or the like and can be connected to the power source. The charging port is electrically connected to the traction battery via the switch arrangement. The switch arrangement has at least one switch, for example just a single switch or multiple switches.

Whenever the switch arrangement is mentioned in this description, this always means at least one switch. The at least one switch is preferably in the form of a contactor. The switch arrangement or at the least one switch serves to selectively establish or interrupt the electrical connection between the traction battery and the charging port. For this purpose, the switch arrangement can be set to different switching states, namely at least the first switching state and the second switching state. In the first switching state, the electrical connection between the traction battery and the charging port is interrupted, whereas in the second switching state it is established.

To charge the traction battery using electrical energy provided at the charging port, it is necessary to set the switch arrangement to the second switching state. The traction battery is preferably connected via the switch arrangement to an electrical intermediate circuit to which the drive device and the charging port are also electrically connected. If the switch arrangement is in the first switching state, the traction battery is electrically disconnected from the intermediate circuit and is electrically connected thereto when the second switching state is present.

Consequently, in order to carry out a driving operation of the motor vehicle during which a drive torque other than zero is provided by means of the drive device, as well as to charge the traction battery with externally provided electrical energy, the switch arrangement must be closed and accordingly be in the second switching state. When not in use and not charging, however, the switch arrangement is set to the first switching state in order to interrupt the electrical connection between the traction battery and the charging port or the intermediate circuit. This is done, on the one hand, to achieve a high level of safety for the motor vehicle and, on the other hand, to prevent unwanted discharge of the traction battery.

In principle, it is therefore intended to set the switch arrangement to the second switching state during charging of the traction battery and to the first switching state when charging is terminated. If the traction battery is to be recharged or charging is to be continued, the switch arrangement must be moved from the first switching state to the second switching state again. If the traction battery is charged with electrical energy that comes from a power source with fluctuating electrical output, it may happen that the charging is terminated due to insufficient charging output, and the switch arrangement is accordingly switched from the second switching state to the first switching state. If sufficient electrical power is subsequently available again, charging is resumed and the switch arrangement is moved from the first switching state to the second switching state. This can cause the switch arrangement to switch between the first switching state and the second switching state or vice versa at high frequency. This can cause severe wear to the switch assembly.

For this reason, according to the invention, it is intended to determine the charging output during charging of the traction battery using the electrical energy provided at the charging port, wherein the switch arrangement is set to the second switching state. The charging output is the electrical output with which the traction battery is charged during charging. As long as the charging output is at least equal to the power threshold, i.e., equal to or greater than the output threshold, charging of the traction battery will continue until the charge level of the traction battery corresponds to a desired charge level.

However, if the charging output falls below the output threshold, i.e., is less than output threshold, charging of the traction battery is terminated. Normally in this case, the switch arrangement would be moved from the second switching state to the first switching state. According to the invention, however, it is intended to first determine, on the basis of the at least one state variable, the time period which describes an expected period of time after which charging of the traction battery will be possible again, namely because a sufficiently large electrical output is again available at the charging port.

If the time duration falls below the time threshold value, i.e., if it is smaller than the threshold value, the switch arrangement is kept in the second switching state, i.e., is not switched to the second switching state. In the event that only a short period of time is expected to elapse before the traction battery can be recharged again, the switch arrangement is not opened and the traction battery is kept in electrical connection with the charging port or the intermediate circuit. If, however, the time duration exceeds the time threshold, i.e., if it is greater than or equal to the time threshold, the switch arrangement is moved from the second switching state to the first switching state according to the usual procedure and the electrical connection between the traction battery and the charging port or the intermediate circuit is interrupted accordingly.

The procedure described is particularly useful if the electrical energy provided at the charging port is in the form of renewable energy, for example, provided by a photovoltaic system. This approach is particularly useful if at least one other consumer is electrically connected to the photovoltaic system and operated with the electrical energy provided by the photovoltaic system. In this case, the traction battery should only be charged with a part of the electrical energy provided by the photovoltaic system, namely with surplus energy that is still available after the supplier of at least one other consumer.

In other words, the traction battery should only be charged with a charging output that corresponds to surplus output, i.e., the electrical source output provided by the photovoltaic system less an electrical consumer output necessary to operate at least one consumer. Since both the source output and the consumer output change over time, the usual procedure would result in frequent switching of the switch arrangement between its switching states and, accordingly, high wear of the switch arrangement. This can be reliably avoided with the procedure explained.

In a further development of the invention, electrical energy generated by a photovoltaic system is used to charge the traction battery. Such a configuration has already been mentioned. The photovoltaic system converts solar energy into electrical energy and makes it available with a specific electrical output, which is referred to as source output. Source output can change rapidly due to environmental conditions, such as weather conditions, shading, or the like. For this reason, the described method is particularly advantageous for the electrical energy provided using the photovoltaic system.

In a further development of the invention, the charging connection of the motor vehicle is connected to the same electrical junction box of a building as the photovoltaic system. The photovoltaic system is associated with the building, in particular it is located on the building or at least in the vicinity of the building. For example, the photovoltaic system is located on the roof of the building. The photovoltaic system, as well as the charging port of the vehicle, is electrically connected to the junction box of the building. For example, the charging port is electrically connected to a charging device spaced apart from the motor vehicle, in particular continuously conductively or wired or at least partially wirelessly.

The charging device is in the form of a wall box or similar, for example, and is connected to the junction box. This means that the wall box is supplied with electrical energy either from the photovoltaic system, the junction box, or both. It is particularly advantageous if the charging device is only supplied with energy that is provided by the photovoltaic system and not required by the at least one other consumer. This makes the advantages of the described approach particularly clear.

In a further development of the invention, the time duration is determined using a predicted progression of the at least one state variable. This means that not just one instantaneous value of the state variable, but a plurality of values is used to determine the time period. The majority of values for the state variable describe its temporal progression, in particular for the future. The progression of the state variable is therefore a temporal progression and includes values of the state variable for the future starting from a current point in time. Based on the predicted progression of the state variable, the future availability of the charging output can be determined particularly precisely.

In a further development of the invention, a photovoltaic output of the photovoltaic system and/or a building power demand of the building and/or an surplus output determined from the photovoltaic output and the building power demand is used as the at least one state variable. The photovoltaic output corresponds to the source output already mentioned and indicates the electrical output provided by the photovoltaic system. The building power demand describes the electrical output required by the building or at least one consumer.

The surplus output can also be used as a state variable. This results from the difference between the photovoltaic output and the building power demand and describes by what power difference the photovoltaic output exceeds the building power demand. The surplus power is preferably limited to a lower value of zero; i.e., if the building power demand is greater than the photovoltaic output, the surplus output is zero; otherwise, it corresponds to the difference between the photovoltaic output and the building power demand. It may be intended to use just one of the above-mentioned variables as a state variable. However, it is particularly preferred to use multiple or even all of the above-mentioned variables in order to enable a particularly accurate determination of the time duration.

In a further development of the invention, after the charging process has been terminated, the charging process is resumed as soon as an electrical output is available that exceeds a further output threshold value. If the charging output falls below the output threshold, charging is not completely stopped, but merely suspended or paused. If the electrical output available at the charging port is again sufficient to continue charging the traction battery, charging will be resumed or continued. The traction battery is then charged until either the charge level of the traction battery corresponds to the desired charge level or the charging output falls below the output threshold again.

Charging will resume as soon as the electrical output exceeds the further output threshold, i.e., is greater than the threshold. The further output threshold may be the same as the output threshold already mentioned, but preferably is different from it. For example, the further output threshold is chosen to be greater than the output threshold, so that the termination and resumption of charging occurs with a hysteresis depending on the available electrical output. This reliably prevents charging from being stopped and restarted too frequently. All in all, the advantages already mentioned are obtained with the procedure described.

In a further development of the invention, in order to resume charging, the switch arrangement is set to the second switching state when the first switching state is present and is held in the second switching state when the second switching state is present. When resuming charging, a distinction is made as to whether the switch arrangement is in the first switching state or in the second switching state. In any case, the switch arrangement is set such that the second switching state is subsequently present. This makes it easy to charge the traction battery using the electrical energy provided at the charging port.

In a further development of the invention, the charging output is set by setting a charger of the motor vehicle to a lower first value to terminate charging and, when charging is resumed, to a higher second value. The charger is preferably part of the motor vehicle, but can also be part of the charging device or charging station. The charger controls the charging output, i.e., the electrical output with which electrical energy is supplied to the traction battery from the charging port.

If charging of the traction battery is terminated because the charging output has fallen below the output threshold, no or only a small amount of electrical energy should subsequently be supplied to the traction battery even though the electrical connection between the traction battery and the charging port is still established. Accordingly, in this case the charging output is set to the first value. If charging is resumed because the available electrical output is sufficient, the charging output is set to the second value. The second value is greater than the first value. Preferably, the first value is zero or at least close to zero. The advantages already mentioned are obtained with the procedure described.

The invention further relates to a motor vehicle, in particular for carrying out the method according to the statements in the context of this description, wherein the motor vehicle has an electric drive device, a traction battery electrically connected to the drive device, and a charging port electrically connected to the traction battery via a switch arrangement, and wherein the motor vehicle is provided and designed to open the switch arrangement in a first switching state to interrupt an electrical connection between the traction battery and the charging port and to close it in a second switching state to establish the electrical connection.

The motor vehicle is also intended and designed to determine a charging output during charging of the traction battery by means of electrical energy provided at the charging port with the switch arrangement set to the second switching state, and if the charging output falls below a threshold value, the charging of the traction battery is terminated, wherein a time period until a new charging of the traction battery is predictively determined based on at least one state variable and the switch arrangement is held in the second switching state if the time period falls below a time threshold value and is set to the first switching state if the time period exceeds the time threshold value.

The advantages of such a design of the motor vehicle or of such a procedure have already been discussed. Both the motor vehicle and the method for operating it can be further developed according to the statements in this description, which will therefore be referenced. Of course, the invention also relates to a motor vehicle arrangement which has the described motor vehicle and additionally has, for example, the photovoltaic system and/or the electrical junction box and/or the building and/or the charging device. Furthermore, the invention also relates to a motor vehicle and a method for operating such a motor vehicle arrangement.

In addition, the invention relates to a computer program product comprising instructions which cause the motor vehicle to carry out the method explained in accordance with the embodiments of this description. Regarding the advantages and possible advantageous further developments, reference should be made to the description as a whole.

The features and feature combinations described in the description, in particular the features and feature combinations described below in the description of the figures and/or shown in the figures may be used not only in the respective combination specified, but also in other combinations or alone, without departing from the scope of the invention. The invention should therefore also be considered to comprise embodiments that are explicitly not shown or explained in the description and/or the figures, but emerge from the explained embodiments or can be derived from them.

### BRIEF DESCRIPTION OF THE FIGURE(S)

In the following, the invention will be explained in greater detail with reference to the exemplary embodiments depicted in the drawings, without this restricting the invention. In particular, the only

FIG. 1 is a schematic representation of a motor vehicle arrangement with a motor vehicle having a traction battery which is charged with electrical energy provided via a charging port of the motor vehicle.

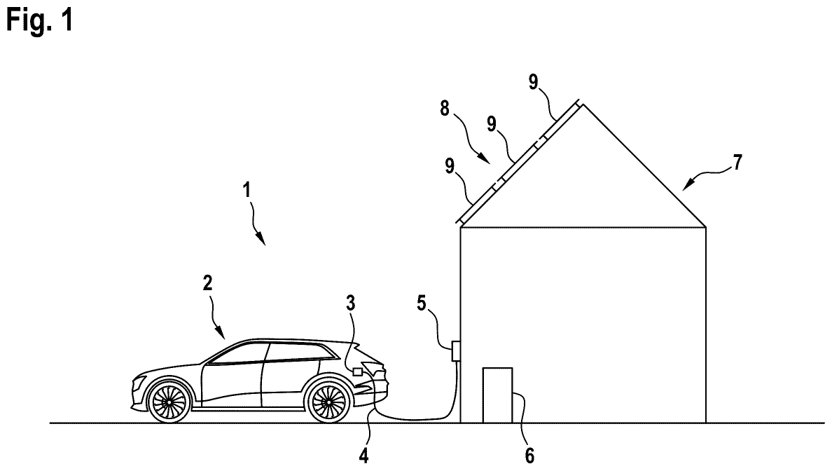

### DETAILED DESCRIPTION

The invention relates to a motor vehicle arrangement 1 with a motor vehicle 2, which has a drive device not shown here and a traction battery, which is also not visible. The motor vehicle 2 has a charging port 3 via which electrical energy is supplied to it at least temporarily for charging the traction battery. In the illustrated exemplary embodiment, the charging port 3 is connected conductively, i.e., for example, via a charging cable 4 to a charging device 5, for example a wall box. The charging device 5 is electrically connected to a junction box 6 of a building 7, which is only outlined here. Likewise, a photovoltaic system 8, for example having multiple photovoltaic modules 9, is connected to the junction box 6 and thus to the charging device 5.

Between the charging port 3 and the traction battery there is an electric switch arrangement not shown here. This can be set to different switching states, such that in a first switching state an electrical connection between the traction battery and the charging port 3 is interrupted and in a second switching state it is established. To charge the traction battery, the charging device 5 is to provide electrical energy at the charging port 3, which energy was generated by means of the photovoltaic system 8. In particular, only that part of the electrical energy which is not required to operate the building 7, for example to operate a consumer of the building 7, should be used to charge the traction battery. In this respect, the electrical energy is only provided via the charging port 3 with an surplus output by which the photovoltaic output of the photovoltaic system 8 exceeds a building power demand of the building 7.

If the available charging output falls below an output threshold during charging of the traction battery, charging should initially be paused. In addition, based on at least one state variable, a time duration is determined which is expected to elapse until the traction battery needs to be recharged. If the time duration is less than a time threshold value, the switch arrangement is kept in the second switching state, so that the electrical connection between the charging port 3 and the traction battery is maintained. If the available electrical output subsequently exceeds the output threshold or a further output threshold, charging of the traction battery continues.

If, however, the time duration is greater than the time threshold, the charging is finally aborted and the switch arrangement is set from the second switching state to the first switching state, so that the electrical connection between the charging port 3 and the traction battery is interrupted. The procedure described prevents the switch assembly from being switched too frequently, thus reducing the associated wear on the switch assembly.

### LIST OF REFERENCE NUMERALS

1 motor vehicle arrangement
2 motor vehicle
3 charging port
4 charging cable
5 charging device
6 junction box
7 building
8 photovoltaic system
9 photovoltaic module

1. A method for operating a motor vehicle, with an electric drive device, a traction battery electrically connected to the drive device, and a charging port electrically connected to the traction battery via a switch arrangement, wherein the switch arrangement is opened in a first switching state to interrupt an electrical connection between the traction battery and the charging port and closed in a second switching state to establish the electrical connection, characterized in that, during charging of the traction battery by means of electrical energy provided at the charging port with the switch arrangement set to the second switching state, a charging output is determined and if the charging output falls below an output threshold value, the charging of the traction battery is terminated, wherein a time duration until a renewed charging of the traction battery is determined predictively on the basis of at least one state variable and the switch arrangement is held in the second switching state if the time duration falls below a time threshold value and is set to the first switching state if the time duration exceeds the time threshold value.

2. The method according to claim 1, wherein electrical energy generated by means of a photovoltaic system is used to charge the traction battery.

3. The method according to claim 1, wherein the charging port of the motor vehicle is connected to the same electrical junction box of a building as the photovoltaic system.

4. The method according to claim 1, wherein the time duration is determined using a predicted progression of the at least one state variable.

5. The method according to claim 1, wherein a photovoltaic output of the photovoltaic system and/or a building power demand of the building and/or a surplus output determined from the photovoltaic power and the building power demand is used as the at least one state variable.

6. The method according to claim 1, wherein, after termination of the charging, the charging is resumed as soon as an electrical output is available which exceeds a further output threshold value.

7. The method according to claim 1, wherein, for resuming charging, the switch arrangement is set to the second switching state when the first switching state is present and is held in the second switching state when the second switching state is present.

8. The method according to claim 1, wherein, to terminate charging, the charging output is set by setting a charging device of the motor vehicle to a lower first value and, when resuming charging, to a higher second value.

9. A motor vehicle, for carrying out the method according claim 1, wherein the motor vehicle has an electric drive device, a traction battery electrically connected to the drive device, and a charging port electrically connected to the traction battery via a switch arrangement, and wherein the motor vehicle is intended and configured to open the switch arrangement in a first switching state to interrupt an electrical connection between the traction battery and the charging port and to close it in a second switching state to establish the electrical connection, characterized in that the motor vehicle is in addition intended and configured to determine a charging output during charging of the traction battery by means of electrical energy provided at the charging port with the switch arrangement set to the second switching state, and if the charging output falls below an output threshold value, to terminate the charging of the traction battery, wherein a time duration until a renewed charging of the traction battery is determined predictively on the basis of at least one state variable and the switch arrangement is held in the second switching state if the time duration falls below a time threshold value and is set to the first switching state if the time duration exceeds the time threshold value.

10. A computer program product comprising commands, which cause a motor vehicle according to carry out the method according to claim 1.

11. The method according to claim 2, wherein the charging port of the motor vehicle is connected to the same electrical junction box of a building as the photovoltaic system.

12. The method according to claim 2, wherein the time duration is determined using a predicted progression of the at least one state variable.

13. The method according to claim 3, wherein the time duration is determined using a predicted progression of the at least one state variable.

14. The method according to claim 2, wherein a photovoltaic output of the photovoltaic system and/or a building power demand of the building and/or a surplus output determined from the photovoltaic power and the building power demand is used as the at least one state variable.

15. The method according to claim 3, wherein a photovoltaic output of the photovoltaic system and/or a building power demand of the building and/or a surplus output determined from the photovoltaic power and the building power demand is used as the at least one state variable.

16. The method according to claim 4, wherein a photovoltaic output of the photovoltaic system and/or a building power demand of the building and/or a surplus output determined from the photovoltaic power and the building power demand is used as the at least one state variable.

17. The method according to claim 2, wherein, after termination of the charging, the charging is resumed as soon as an electrical output is available which exceeds a further output threshold value.

18. The method according to claim 3, wherein, after termination of the charging, the charging is resumed as soon as an electrical output is available which exceeds a further output threshold value.

19. The method according to claim 4, wherein, after termination of the charging, the charging is resumed as soon as an electrical output is available which exceeds a further output threshold value.

20. The method according to claim 5, wherein, after termination of the charging, the charging is resumed as soon as an electrical output is available which exceeds a further output threshold value.
